(19) United States
(12) Patent Application Publication
(10) Pub. No.: US 2023/0418375 A1
(43) Pub. Date: Dec. 28, 2023

(54) DISPLAY APPARATUS, METHOD OF CONTROLLING DISPLAY APPARATUS, AND NON-TRANSITORY COMPUTER READABLE RECORDING MEDIUM

(71) Applicant: JVCKENWOOD Corporation, Yokohama-shi (JP)

(72) Inventor: Hiroshi Noguchi, Yokohama-shi (JP)

(21) Appl. No.: 18/465,200

(22) Filed: Sep. 12, 2023

Related U.S. Application Data
(63) Continuation of application No. PCT/JP2022/009251, filed on Mar. 3, 2022.

(30) Foreign Application Priority Data
Mar. 23, 2021 (JP) 2021-049286

(51) Int. Cl. G06F 3/01; G02B 27/00; G02B 27/01

(52) U.S. Cl. CPC G06F 3/013; G02B 27/0093; G02B 27/0179; G02B 27/017; G02B 2027/0187

(57) ABSTRACT

A display apparatus that is worn on a user and provides a virtual space to the user, the display apparatus includes a virtual space information acquisition unit that acquires information on a virtual movement region in which the user is movable in the virtual space, a real space information acquisition unit that acquires information on a real movement region in which the user is movable in a real space in which the user exists, a correspondence relation acquisition unit that calculates a superimposed area that is an area in which the virtual movement region and the real movement region are superimposed on each other when the virtual space and the real space are superimposed on each other, and acquires a correspondence relation between the virtual space and the real space, the correspondence relation being set based on the superimposed area, and a display control unit.

### CROSS-REFERENCE TO RELATED APPLICATIONS

This application is a Continuation of PCT International Application No. PCT/JP2022/009251 filed on Mar. 3, 2022 which claims the benefit of priority from Japanese Patent Application No. 2021-049286 filed on Mar. 23, 2021, the entire contents of both of which are incorporated herein by reference.

### BACKGROUND

### 1. Technical Field

The present disclosure relates to a display apparatus, a method of controlling the display apparatus, and a non-transitory computer readable recording medium.

### 2. Description of the Related Art

In recent years, information equipment has largely advanced. Not only a smartphone that is one of representative examples of the information equipment, but also what is called a wearable device is becoming popular. As the wearable device, an eyeglass-type head mounted display (HMD) that directly gives a visual stimulus is known. With use of the HMD as described above, it is possible to provide a virtual space to a user U by displaying a video in accordance with a line-of-sight direction of the user. For example, Japanese Laid-open Patent Publication No. H9-311618 describes a technology for storing coordinate data that is obtained from a three-dimensional sensor as a reference coordinate in a real three-dimensional space, and correcting a viewpoint position of a user by matching the viewpoint position with a reference position in a virtual three-dimensional space.

In the display apparatus as described above, there is a need to appropriately provide a virtual space to a user.

### SUMMARY

It is an object of the present disclosure to at least partially solve the problems in the conventional technology.

A display apparatus according to an embodiment that is worn on a user and provides a virtual space to the user is disclosed. The display apparatus includes a virtual space information acquisition unit that acquires information on a virtual movement region in which the user is movable in the virtual space, a real space information acquisition unit that acquires information on a real movement region in which the user is movable in a real space in which the user exists, a correspondence relation acquisition unit that calculates a superimposed area that is an area in which the virtual movement region and the real movement region are superimposed on each other when the virtual space and the real space are superimposed on each other, and acquires a correspondence relation between the virtual space and the real space, the correspondence relation being set based on the superimposed area, and a display control unit that causes a display unit to display an image for the virtual space based on the correspondence relation and a position of the display apparatus in the real space. The correspondence relation acquisition unit calculates the superimposed area for each of combinations of the virtual space and the real space for which at least one of a relative position and a relative orientation of the virtual space and the real space is moved, and acquires a correspondence relation for which the superimposed area is maximum among the superimposed areas.

A method according to an embodiment of controlling a display apparatus that is worn on a user and provides a virtual space to the user is disclosed. The method includes acquiring information on a virtual movement region in which the user is movable in the virtual space, acquiring information on a real movement region in which the user is movable in a real space in which the user exists, calculating a superimposed area that is an area in which the virtual movement region and the real movement region are superimposed on each other when the virtual space and the real space are superimposed on each other, and acquiring a correspondence relation between the virtual space and the real space, the correspondence relation being set based on the superimposed area, and causing a display unit to display an image for the virtual space based on the correspondence relation and a position of the display apparatus in the real space. The calculating includes calculating the superimposed area for each of combinations of the virtual space and the real space for which at least one of a relative position and a relative orientation of the virtual space and the real space is moved, and acquiring a correspondence relation for which the superimposed area is maximum among the superimposed areas.

A non-transitory computer readable recording medium according to an embodiment on which an executable program is recorded is disclosed. The program causes a computer to implement a method of controlling a display apparatus that is worn on a user and provides a virtual space to the user. The program causes the computer to execute acquiring information on a virtual movement region in which the user is movable in the virtual space, acquiring information on a real movement region in which the user is movable in a real space in which the user exists, calculating a superimposed area that is an area in which the virtual movement region and the real movement region are superimposed on each other when the virtual space and the real space are superimposed on each other, and acquiring a correspondence relation between the virtual space and the real space, the correspondence relation being set based on the superimposed area, and causing a display unit to display an image for the virtual space based on the correspondence relation and a position of the display apparatus in the real space. The calculating includes calculating the superimposed area for each of combinations of the virtual space and the real space for which at least one of a relative position and a relative orientation of the virtual space and the real space is moved, and acquiring a correspondence relation for which the superimposed area is maximum among the superimposed areas.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram for explaining an example of a real space and a virtual space;

FIG. 2 is a schematic block diagram of a display apparatus according to the present embodiment;

FIG. 3 is a schematic diagram illustrating an example of the virtual space;

FIG. 4 is a schematic diagram illustrating an example of the real space;

FIG. 5 is a schematic diagram illustrating an example of superimposition of the virtual space and the real space;

FIG. 6 is a schematic diagram illustrating another example of superimposition of the virtual space and the real space;

FIG. 7 is a flowchart for explaining a flow of displaying an image of the virtual space;

FIG. 8 is a schematic diagram for explaining an example of a priority region;

FIG. 9 is a schematic diagram illustrating still another example of superimposition of the virtual space and the real space;

FIG. 10 is a schematic diagram illustrating an example in which a user visually recognizes the virtual space; and

FIG. 11 is a schematic diagram illustrating still another example of superimposition of the virtual space and the real space.

### DETAILED DESCRIPTION OF THE PREFERRED EMBODIMENTS

Embodiments will be described in detail below based on the drawings. The present embodiments are not limited by the embodiments described below.

Real Space and Virtual Space

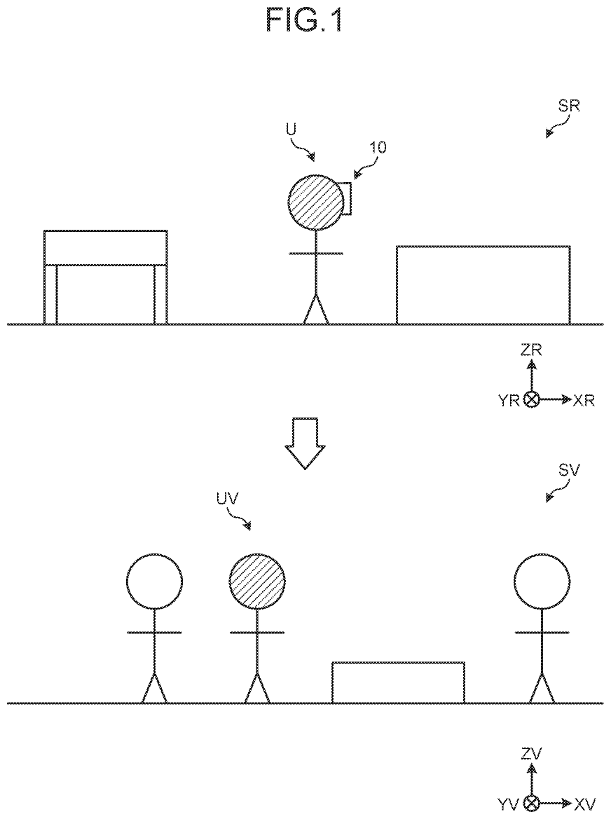

FIG. 1 is a schematic diagram for explaining an example of a real space and a virtual space. A display apparatus 10 according to the present embodiment is a display apparatus that displays an image. As illustrated in FIG. 1, the display apparatus 10 is what is called a head mounted display (HMD) that is mounted on a head of a user U. The display apparatus 10 provides a virtual space to the user U by displaying an image. As illustrated in FIG. 1, it is assumed that an actual space in which the user U actually exists is referred to as a real space SR, and a virtual space that is provided to the user U by the display apparatus 10 is referred to as a virtual space SV. In this case, the display apparatus 10 displays an image for the virtual space SV in accordance with action (line of sight) of the user U in the real space SR. In other words, the image for the virtual space SV is displayed by simulating that the user U acts, as an avatar UV, in the virtual space SV. Therefore, the user U is able to recognize that the user U is present in the virtual space SV. Meanwhile, the virtual space SV described herein is mixed reality (MR), that is, a space in which a real place distant from a place in which the user U exits is reproduced; however, embodiments are not limited to this example, and it may be possible to adopt a virtual space that does not actually exist, that is, virtual reality (VR). In the following, in the coordinate system of the real space SR, one direction along a horizontal direction is referred to as an XR direction, a direction perpendicular to the XR direction along the horizontal direction is referred to as a YR direction, and a vertical direction is referred to as a ZR direction. Further, in the coordinate system of the virtual space SV, one direction along a horizontal direction is referred to as an XV direction, a direction perpendicular to the XV direction along the horizontal direction is referred to as an YV direction, and a vertical direction is referred to as a ZV direction.

Display Apparatus

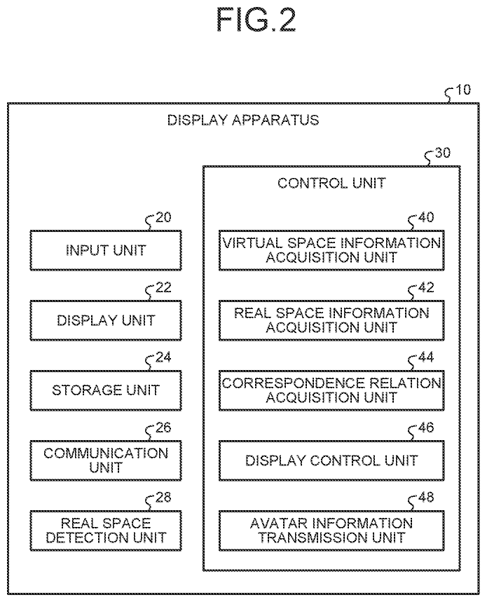

FIG. 2 is a schematic block diagram of the display apparatus according to the present embodiment. The display apparatus 10 is also referred to as a computer and includes, as illustrated in FIG. 2, an input unit 20, a display unit 22, a storage unit 24, a communication unit 26, a real space detection unit 28, and a control unit 30. The input unit 20 is a mechanism that receives operation performed by the user U, and may be, for example, a controller, a microphone, or the like that is arranged in the HMD. The display unit 22 is a display for displaying an image. The display unit 22 provides the virtual space SV to the user U by outputting an image. The display apparatus 10 may include, for example, a certain apparatus that outputs information, such as a speaker that outputs voice, in addition to the display unit 22.

The storage unit 24 is a memory for storing various kinds of information, such as calculation details or a program for the control unit 30, and includes, for example, at least one of a main storage device, such as a random access memory (RAM) or a read only memory (ROM), and an external storage device, such as a hard disk drive (HDD). The program for the control unit 30 stored in the storage unit 24 may be stored in a recording medium that is readable by the display apparatus 10.

The communication unit 26 is a communication module that performs communication with an external apparatus, and may be, for example, an antenna or the like. The display apparatus 10 communicates with an external apparatus by wireless communication, but wired communication may be used and an arbitrary communication method is applicable.

The real space detection unit 28 is a sensor that detects surroundings of the display apparatus 10 (the user U) in the real space SR. The real space detection unit 28 detects an object that is present around the display apparatus 10 (the user U) in the real space SR, and is a camera in the present embodiment. However, the real space detection unit 28 is not limited to the camera as long as it is possible to detect an object that is present in the real space SR around the display apparatus 10 (the user U), and may be, for example, light detection and ranging (LIDAR) or the like.

The control unit 30 is an arithmetic device and includes, for example, an arithmetic circuit, such as a central processing unit (CPU). The control unit 30 includes a virtual space information acquisition unit 40, a real space information acquisition unit 42, a correspondence relation acquisition unit 44, a display control unit 46, and an avatar information transmission unit 48. The control unit 30, by reading a program (software) from the storage unit 24 and executing the program, implements the virtual space information acquisition unit 40, the real space information acquisition unit 42, the correspondence relation acquisition unit 44, the display control unit 46, and the avatar information transmission unit 48, and performs processes of the above-described units. Meanwhile, the control unit 30 may perform the processes by a single CPU, or may include a plurality of CPUs and perform the processes by the plurality of CPUs. Further, at least a part of the processes of the virtual space information acquisition unit 40, the real space information acquisition unit 42, the correspondence relation acquisition unit 44, the display control unit 46, and the avatar information transmission unit 48 may be implemented by a hardware circuit.

Virtual Space Information Acquisition Unit

The virtual space information acquisition unit 40 acquires information on the virtual space SV. The virtual space information acquisition unit 40 acquires the information on the virtual space SV from an external apparatus (server) via the communication unit 26, for example. The information on the virtual space SV includes image data of the virtual space SV in the coordinate system of the virtual space SV. The image data of the virtual space SV indicates a coordinate or a shape of a target object that is displayed as an image for the virtual space SV. Meanwhile, in the present embodiment, the virtual space SV is not constructed in accordance with an environment around the user U in the real space SR, but is set in advance regardless of the environment around the user U in the real space SR.

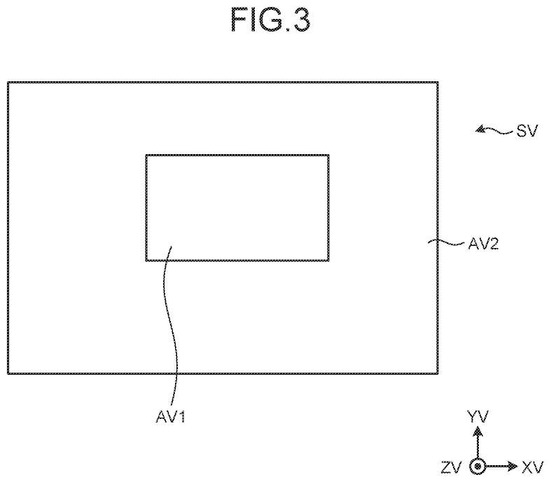

FIG. 3 is a schematic diagram illustrating an example of the virtual space. FIG. 3 is one example of a plan view of the virtual space SV viewed in the ZV direction. The virtual space information acquisition unit 40 also acquires information on a movable region AV2 (virtual movement region) in the virtual space SV as the information on the virtual space SV. In other words, the virtual space information acquisition unit 40 also acquires information indicating a position that is occupied by the movable region AV2 in the coordinate system of the virtual space SV. The movable region AV2 is a region in which the avatar UV of the user U is movable (or a space in which the avatar UV is movable) in the virtual space SV, and may be a region that is obtained by eliminating an unmovable region AV1, which is a region in which the avatar UV of the user U is unmovable (or a space in which the avatar UV is unmovable), from the virtual space SV. The movable region AV2 may be, for example, a floor of a room in which avatars gather in the virtual space SV, and the unmovable region AV1 may be, for example, a region in which an obstacle through which the avatar UV is not able to pass is present in the virtual space SV, a region of interest (for example, a table, a screen, or the like) at a meeting in the virtual space SV, or the like. In the present embodiment, the movable region AV2 may be set in advance when, for example, the virtual space SV is set, or may be set by the virtual space information acquisition unit 40 based on, for example, a size of the avatar UV and a size of the unmovable region AV1.

Meanwhile, in FIG. 3, the virtual space SV and the unmovable region AV1 viewed in the ZV direction are formed in rectangular shapes, but this is a mere example. The shapes and the sizes of the virtual space SV, the unmovable region AV1, and the movable region AV2 are not limited to the example illustrated in FIG. 3 and may be determined arbitrarily.

Real Space Information Acquisition Unit

The real space information acquisition unit 42 acquires information on the real space SR. The information on the real space SR indicates location information that indicates a coordinate or a shape of an object that is present around the display apparatus 10 (the user U) in the coordinate system of the real space SR. In the present embodiment, the real space information acquisition unit 42 controls the real space detection unit 28, causes the real space detection unit 28 to detect the object that is present around the display apparatus 10 (the user U), and acquires a detection result as the information on the real space SR. However, the method of acquiring the information on the real space SR is not limited to detection by the real space detection unit 28. For example, it may be possible to set the information on the real space SR, such as layout information on a room of the user U, in advance, and the real space information acquisition unit 42 may acquire the set information on the real space SR.

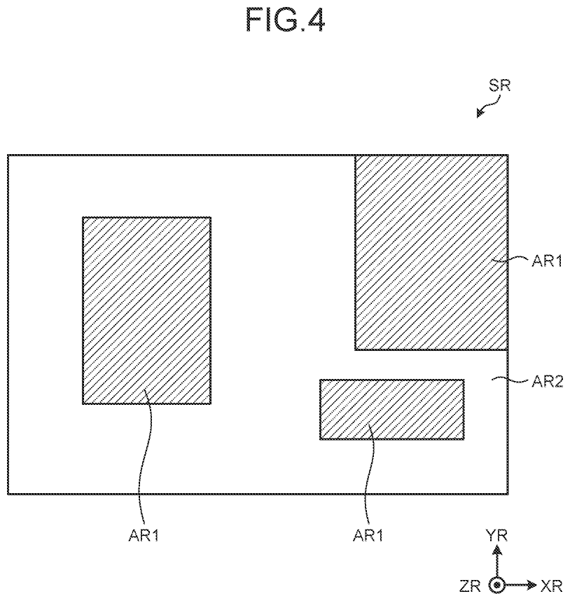

FIG. 4 is a schematic diagram illustrating an example of the real space. FIG. 4 is one example of a plan view of the real space SR viewed in the ZR direction. The real space information acquisition unit 42 acquires information on a movable region AR2 (real movement region) in the real space SR. In other words, the real space information acquisition unit 42 acquires information indicating a position that is occupied by the movable region AR2 in the coordinate system of the real space SR. The movable region AR2 is a region in which the user U is movable (or a space in which the user U is movable) in the real space SR, and may be a region that is obtained by eliminating unmovable regions AR1, which are regions in which the user U is unmovable (or spaces in which the user U is unmovable), from the real space SR. The movable region AR2 may be, for example, a floor of a room in which the user U is present, and the unmovable regions AR1 may be, for example, regions in which obstacles (for example, a table, a bed, and the like) through which the user U is not able to pass in the virtual space SV. In the present embodiment, the real space information acquisition unit 42 sets the movable region AR2 and the unmovable regions AR1 based on the information on the real space SR. The real space information acquisition unit 42 may identify positions of the obstacles through which the user U is not movable based on the information on the real space SR, set regions (or spaces) that are occupied by the objects through which the user U is not movable as the unmovable regions AR1, and set a region (or a space) in which the objects through which the user U is not movable is not present as the movable region AR2. However, the movable region AR2 and the unmovable regions AR1 need not always be set based on the information on the real space SR. For example, it may be possible to set information on the movable region AR2 and the unmovable regions AR1, such as the layout information on the room of the user U, in advance, and the real space information acquisition unit 42 may acquire the set information on the movable region AR2 and the unmovable region AR1.

Meanwhile, FIG. 4 is a mere example. The shapes and the sizes of the real space SR, the unmovable regions AR1, and the movable region AR2 are not limited to the example illustrated in FIG. 4 and may be determined arbitrarily.

Correspondence Relation Acquisition Unit

The correspondence relation acquisition unit 44 sets a correspondence relation between the coordinate system of the virtual space SV and the coordinate system of the real space SR based on the information on the movable region AV2 that is acquired by the virtual space information acquisition unit 40 and the information on the movable region AR2 that is acquired by the real space information acquisition unit 42. The correspondence relation between the coordinate system of the virtual space SV and the coordinate system of the real space SR may be information indicating a position and posture of the real space SR in the coordinate system of the virtual space SV, and may be a value for converting the coordinate system of the real space SR to the coordinate system of the virtual space SV. For example, when the user U is present at a reference position in the real space SV, the display apparatus 10 displays an image of the virtual space SV such that a viewpoint of the user U (the avatar UV) is present at a certain position in the virtual space SV corresponding to the reference position in the real space SV. A process performed by the correspondence relation acquisition unit 44 will be described in detail below.

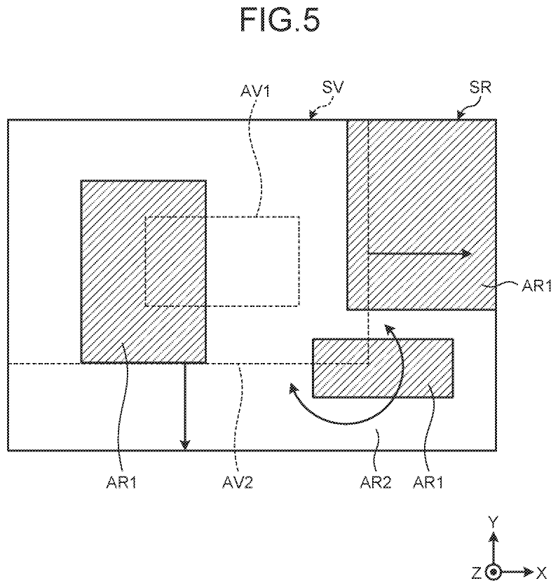

FIG. 5 is a schematic diagram illustrating an example of superimposition of the virtual space and the real space. The correspondence relation acquisition unit 44 superimposes the virtual space SV that is acquired by the virtual space information acquisition unit 40 and the real space SR that is acquired by the real space information acquisition unit 42 with each other in a common coordinate system. In other words, the correspondence relation acquisition unit 44 converts the coordinates of the unmovable region AV1 and the movable region AV2 in the virtual space SV and the coordinates of the unmovable regions AR1 and the movable region AR2 in the real space SR to the common coordinate system, and superimposes the unmovable region AV1, the movable region AV2, the unmovable regions AR1, and the movable region AR2 with one another in the common coordinate system. Meanwhile, the common coordinate system may be an arbitrary coordinate system. In the example in FIG. 5, in the common coordinate system, one direction along a horizontal direction is referred to as an X direction, a direction perpendicular to the X direction along the horizontal direction is referred to as a Y direction, and a vertical direction is referred to as a Z direction.

The correspondence relation acquisition unit 44 calculates, as a superimposed area, an area of a region in which the movable region AV2 and the movable region AR2 are superimposed on each other (or a volume of a superimposed space) when the virtual space SV and the real space SR are superimposed on each other in the common coordinate system. The correspondence relation acquisition unit 44 calculates a correspondence relation between the coordinate system of the virtual space SV and the coordinate system of the real space SR based on the calculated superimposed area.

In the present embodiment, as illustrated in the example in FIG. 5, the correspondence relation acquisition unit 44 calculates the superimposed area while moving at least one of a relative position and a relative orientation of the virtual space SV and the real space SR in the common coordinate system. In other words, the correspondence relation acquisition unit 44 calculates the superimposed area in which the movable region AV2 and the movable region AR2 are superimposed on each other, for each of the virtual space SV and the real space SR for which at least one of the relative position and the relative orientation is different in the common coordinate system. Meanwhile, in the example in FIG. 5, the example is illustrated in which the position and the orientation of the real space SV are fixed and the position and the orientation of the virtual space SR are moved in the common coordinate system; however, embodiments are not limited to this example, and it may be possible to calculate the superimposed area by fixing the position and the orientation of the virtual space SR and moving the position and the orientation of the real space SV.

The correspondence relation acquisition unit 44 sets a correspondence relation between the coordinate system of the virtual space SV and the coordinate system of the real space SR based on the superimposed area of each of combinations of the virtual space SV and the real space SR for which at least one of the relative position and the relative orientation is different in the common coordinate system. More specifically, the correspondence relation acquisition unit 44 extracts a combination of the virtual space SV and the real space SR for which the superimposed area is maximum from among the combinations of the virtual space SV and the real space SR for which at least one of the relative position and the relative orientation is different. Further, the correspondence relation acquisition unit 44 calculates the correspondence relation between the coordinate system of the extracted virtual space SV and the coordinate system of the extracted real space SR (a value for converting the coordinate system of the extracted real space SR to the coordinate system of the extracted virtual space SV), and sets the calculated correspondence relation as the correspondence relation between the coordinate system of the virtual space SV and the coordinate system of the real space SR. In other words, the correspondence relation acquisition unit 44 extracts the virtual space SV located at a certain position and oriented in a certain direction with which the superimposed area is maximum, and associates the extracted coordinate system of the virtual space SV with the coordinate system of the real space SR.

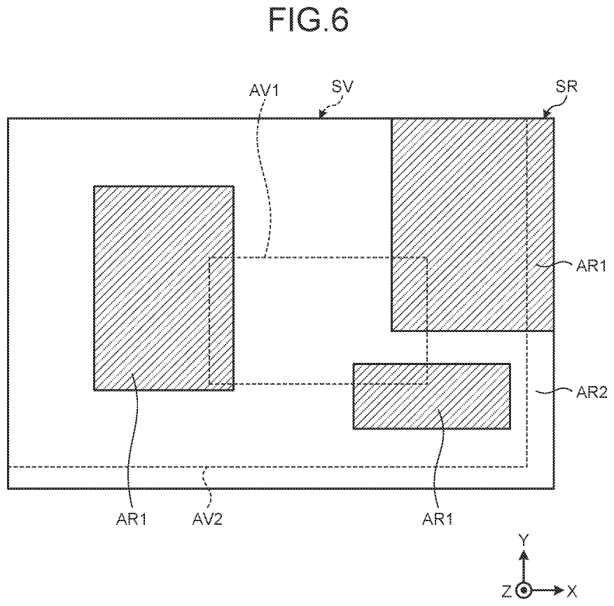

FIG. 6 is a schematic diagram illustrating another example of superimposition of the virtual space and the real space. In the explanation of FIG. 5, the correspondence relation acquisition unit 44 superimposes the virtual space SV on the real space SR while fixing the size of the virtual space SV and changing the position and the orientation of the virtual space SV; however, as illustrated in FIG. 6, it may be possible to superimpose the virtual space SV on the real space SR while changing the size of the virtual space SV. In this case, as illustrated in the example in FIG. 6, the correspondence relation acquisition unit 44 calculates the superimposed area while changing relative sizes of the virtual space SV and the real space SR in the common coordinate system. In other words, the correspondence relation acquisition unit 44 calculates a superimposed area in which the movable region AV2 and the movable region AR2 are superimposed on each other, for each of combinations of the virtual space SV and the real space SR for which the relative size is different in the common coordinate system. Meanwhile, even when the relative size is changed, it is preferable to fix area ratios of the unmovable region AV1 and the movable region AV2 to the virtual space SV and area ratios of the unmovable regions AR1 and the movable region AR2 to the real space SR. In other words, it is preferable to uniformly enlarge or reduce entire regions of the virtual space SV and the real space SR instead of enlarging or reducing a part of the virtual space SV and the real space SR. Further, in the example in FIG. 6, the example is illustrated in which, in the common coordinate system, the size of the real space SV is fixed and the size of the virtual space SR is changed, but embodiments are not limited to this example. It may be possible to calculate the superimposed area while fixing the size of the virtual space SR and changing the size of the real space SV.

In the example illustrated in FIG. 6, the correspondence relation acquisition unit 44 sets the correspondence relation between the coordinate system of the virtual space SV and the coordinate system of the real space SR based on the superimposed area of each of combinations of the virtual space SV and the real space SR for which the relative size is different in the common coordinate system. More specifically, the correspondence relation acquisition unit 44 extracts a combination of the virtual space SV and the real space SR for which the superimposed area is maximum from among the combinations of the virtual space SV and the real space SR for which the relative size is different. Further, the correspondence relation acquisition unit 44 sets the correspondence relation between the coordinate system of the extracted virtual space SV and the coordinate system of the extracted real space SR as the correspondence relation between the coordinate system of the virtual space SV and the coordinate system of the real space SR. In other words, the correspondence relation acquisition unit 44 extracts the virtual space SV at a scale ratio at which the superimposed area is maximum, and associates the coordinate system of the virtual space SV with a size at the extracted scale ratio with the coordinate system of the real space SR.

Meanwhile, the example in FIG. 5 and the example in FIG. 6 may be combined. Specifically, the correspondence relation acquisition unit 44 calculates the superimposed area while changing the relative positions, the relative orientations, and the relative sizes of the virtual space SV and the real space SR in the common coordinate system. Further, the correspondence relation acquisition unit 44 extracts a combination of the virtual space SV and the real space SR for which the superimposed area is maximum from among combinations of the virtual space SV and the real space SR for which at least one of the relative position, the relative orientation, and the relative size is different in the common coordinate system. Furthermore, the correspondence relation acquisition unit 44 sets a correspondence relation between the coordinate system of the extracted virtual space SV and the coordinate system of the extracted real space SR as the correspondence relation between the coordinate system of the virtual space SV and the coordinate system of the real space SR.

In the explanation as described above, the correspondence relation acquisition unit 44 associates the virtual space SV and the real space SR such that the superimposed area between the movable region AV2, which indicates a two-dimensional movable region in the virtual space SV, and the movable region AR2, which indicates a two-dimensional movable region in the real space SR, but the technology is not limited to the case in which the two-dimensional superimposed area is maximized. For example, the correspondence relation acquisition unit 44 may associate the virtual space SV and the real space SR such that a superimposed volume of the movable region AV2 (virtual movement region), which indicates a three-dimensional movable space in the virtual space SV, and the movable region AR2 (real movement region), which indicates a three-dimensional movable space in the real space SR, is maximum.

Furthermore, in the explanation as described above, the correspondence relation acquisition unit 44 calculates the superimposed area by superimposing the virtual space SV and the real space SR in the common coordinate system, and sets the correspondence relation between the coordinate system of the virtual space SV and the coordinate system of the real space SR based on the superimposed area. However, calculation of the superimposed area and setting of the correspondence relation need not always be performed by the correspondence relation acquisition unit 44. For example, an external apparatus may calculate the superimposed area, and the correspondence relation acquisition unit 44 may acquire information on the superimposed area from the external apparatus and set the correspondence relation based on the acquired information. Moreover, for example, the external apparatus may calculate the superimposed area and set the correspondence relation based on the superimposed area, and the correspondence relation acquisition unit 44 may acquire information on the correspondence relation from the external apparatus.

Display Control Unit

The display control unit 46 causes the display unit 22 to display an image for the virtual space SR based on the correspondence relation between the coordinate system of the virtual space SV and the coordinate system of the real space SR set by the correspondence relation acquisition unit 44 and based on the position of the user U (the display apparatus 10) in the real space SR. Specifically, the display control unit 46 acquires information on the position and the orientation of the user U in the real space SR, and converts the position and the orientation of the user U in the real space SR to a position and an orientation of a viewpoint of the user U (the avatar UV) in the coordinate system of the virtual space SV based on the correspondence relation. The display control unit 46 causes the display unit 22 to display, as the image for the virtual space SV, an image of the virtual space SV such that the virtual space SV is viewed at the position and the orientation of the viewpoint of the calculated user U. Meanwhile, it may be possible to acquire the information on the position and posture of the user U (the display apparatus 10) in the real space SR by an arbitrary method; for example, it may be possible to calculate the position and the posture by using a detection result of the real space detection unit 28 (in other words, a captured image of the real space SR).

As described above, the position and the posture of the user U in the real space SR are reflected in the position and the posture of the viewpoint of the user U in the virtual space SV. Therefore, when the user U moves in the real space SR, the position and the posture of the viewpoint of the user U in the virtual space SV (in other words, the position and the posture of the avatar UV) also move. In this case, it is preferable to associate a movement amount of the user U in the real space SR and a movement amount of the viewpoint of the user U in the virtual space SV. More specifically, if the size of the virtual space SV in the common coordinate system is changed when the correspondence relation is set, it is preferable to reflect a degree of change of the size of the virtual space SV in the movement amount. Specifically, assuming that a ratio (reduction scale) of change of the size of the virtual space SV in the common coordinate system is referred to as a change ratio, the display control unit 46 causes the display unit 22 to display the image for the virtual space SV by assuming that the viewpoint of the user U has moved in the virtual space SV by a movement amount corresponding to reciprocal times of the change ratio with respect to the movement amount by which the user U has moved in the real space SR. In other words, the display control unit 46 causes the display unit 22 to display the image of the virtual space SV from a viewpoint that has moved by the movement amount corresponding to the reciprocal times of the change ratio with respect to the movement amount by which the user U has moved in the real space SR. For example, if the size of the virtual space SV is doubled when the correspondence relation is set, the display control unit 46 causes the display unit 22 to display the image of the virtual space SV from a viewpoint that has moved by the movement amount corresponding to a half of the movement amount by which the user U has moved in the real space SR.

Furthermore, the display control unit 46 may display an object that is present in the real space SR, in the image of the virtual space SV in a superimposed manner. In this case, the display unit 22 may provide augmented reality (AR) in which the image of the virtual space SV is displayed in a transparent manner through the real space SR, or may display the image of the virtual space SV and the image indicating an object in the real space SP in a superimposed manner. Moreover, a space portion, which does not overlap with the movable region AR2 in the real space SR, in the movable region AV2 in the virtual space SV may be deleted from the image of the virtual space SV or may be provided as information indicating the unmovable region. In this case, even when a certain region remains as the movable region, if an area in which a spatial width in which the user U (or the avatar UV that reproduces a body shape of the user U) can pass is not ensured in the region, it may be possible to delete the area from the image of the virtual space SV.

The display apparatus 10 according to the present embodiment displays the image for the virtual space SV based on the correspondence relation between the coordinate system of the virtual space SV and the coordinate system of the real space SR that is set as described above, so that it is possible to appropriately provide the virtual space SV to the user U. For example, the user U moves in the real space SR while visually recognizing the virtual space SV. In other words, the user U attempts to move in the movable region AV2 in the virtual space SV, but an area in which the user U is actually movable is the movable region AR2 in the real space SR. In this manner, the movable region that is recognized by the user U and the actually movable region are different. In contrast, in the present embodiment, the virtual space SV and the real space SR are associated with each other such that the superimposed area of the movable region AV2 in the virtual space SV and the movable region AR2 in the real space SR is maximum; therefore, deviation between the movable region that is recognized by the user U and the actually movable region is reduced, so that it is possible to ensure the region in which the user U is movable as wide as possible. Consequently, according to the display apparatus 10, even when the user U moves, it is possible to appropriately provide the virtual space SV.

Avatar Information Transmission Unit

The avatar information transmission unit 48 transmits information on the avatar UV of the user U in the virtual space SV to an external information via the communication unit 26. The avatar information transmission unit 48 acquires the information on the position and the orientation of the user U in the real space SR, and converts the position and the orientation of the user U in the real space SR to the position and the orientation of the avatar UV in the coordinate system of the virtual space SV based on the correspondence relation between the coordinate system of the virtual space SV and the coordinate system of the real space SR. The avatar information transmission unit 48 transmits the information on the position and the orientation of the avatar UV in the coordinate system of the virtual space SV and image data (data indicating a shape or the like) of the avatar UV to an external apparatus. The external apparatus transmits the information on the position and the orientation of the avatar UV in the coordinate system of the virtual space SV and the image data of the avatar UV, as the image data of the virtual space SV, to a display apparatus that is used by a different user. The display apparatus displays image data of a virtual space SVG that includes the image of the avatar UV for a user who is wearing the display apparatus. By transmitting the image data of the avatar to the external apparatus as described above, it is possible to share the virtual space SV among a plurality of users.

Flow of Process

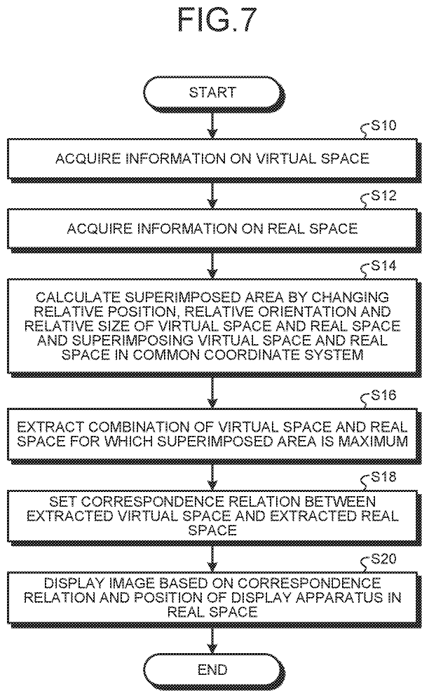

A flow of displaying the image of the virtual space SV as described above will be described below. FIG. 7 is a flowchart for explaining the flow of displaying the image of the virtual space. As illustrated in FIG. 7, the display apparatus 10 causes the virtual space information acquisition unit 40 to acquire the information on the virtual space SV (Step S10), and causes the real space information acquisition unit 42 to acquire the information on the real space SR (Step S12). Further, the display apparatus 10 causes the correspondence relation acquisition unit 44 to calculate a superimposed area by changing at least one of the relative position, the relative orientation, and the relative size of the virtual space SV and the real space SR and superimposing the virtual space SV and the real space SR in the common coordinate system (Step S14). The correspondence relation acquisition unit 44 extracts a combination of the virtual space SV and the real space SR for which the superimposed area is maximum from among combinations of the virtual space SV and the real space SR (Step S16), and sets a correspondence relation between the coordinate system of the extracted virtual space SV and the coordinate system of the extracted real space SR (Step S18). The display apparatus 10 causes the display control unit 46 to cause the display unit 22 to display the image of the virtual space SV based on the set correspondence relation and the position of the display apparatus 10 (the user U) in the real space SR (Step S20).

Effects

As described above, the display apparatus 10 according to the present embodiment is mounted on the user U to provide the virtual space SV to the user U, and includes the virtual space information acquisition unit 40, the real space information acquisition unit 42, the correspondence relation acquisition unit 44, and the display control unit 46. The virtual space information acquisition unit 40 acquires the information on the movable region AV2 (virtual movement region) in which the user U (the avatar UV) is movable in the virtual space SV. The real space information acquisition unit 42 acquires the information on the movable region AR2 (real movement region) in which the user U is movable in the real space SR in which the user U exists. The correspondence relation acquisition unit 44 acquires a correspondence relation between the coordinate system of the virtual space SV and the coordinate system of the real space SR which is set based on a superimposed area. The superimposed area is an area in which the movable region AV2 (virtual movement region) and the movable region AR2 (real movement region) are superimposed on each other when the virtual space SV and the real space SR are superimposed on each other in the common coordinate system. The display control unit 46 causes the display unit 22 to display an image for the virtual space SV based on the correspondence relation and the position of the display apparatus 10 in the real space SR.

When the display apparatus 10 provides the virtual space SV to the user U, the movable region in the virtual space SV that is recognized by the user U and the actually movable region in the real space SR are different from each other. In contrast, the display apparatus 10 according to the present embodiment associates the virtual space SV and the real space SR based on the superimposed area of the movable region AV2 in the virtual space SV and the movable region AR2 in the real space SR, so that deviation between the movable region that is recognized by the user U and the actually movable region is reduced and it is possible to ensure the region in which the user U is movable as wide as possible. Therefore, according to the display apparatus 10, even when the user U moves, it is possible to appropriately provide the virtual space SV.

Furthermore, the correspondence relation indicates association between the coordinate system of the virtual space SV and the coordinate system of the real space SR for which the superimposed area is maximum among combinations of the virtual space SV and the real space SR for which at least one of the relative position and the relative orientation of the virtual space SV and the real space SR is moved in the coordinate system. In this manner, by moving the virtual space SV relative to the real space SR and by associating the virtual space SV and the real space SR with each other such that the superimposed area is maximum, it is possible to ensure the region in which the user U is movable as wide as possible.

Moreover, the correspondence relation indicates association between the coordinate system of the virtual space SV and the coordinate system of the real space SR for which the superimposed area is maximum among combinations of the virtual space SV and the real space SR for which the relative size of the virtual space SV and the real space SR in the common coordinate system is changed. In this manner, by changing the size of the virtual space SV with respect to the real space SR and by associating the virtual space SV and the real space SR with each other such that the superimposed area becomes maximum, it is possible to ensure the region in which the user U is movable as wide as possible.

Furthermore, the display control unit 46 causes the display unit 22 to display the image for the virtual space SV such that the user U has moved in the virtual space SV by a movement amount corresponding to reciprocal times of the change rate at which the size of the virtual space SV is changed in the common coordinate system with respect to the movement amount by which the display apparatus 10 (the user U) has moved in the real space SR. The display apparatus 10 according to the present embodiment sets the movement amount in the virtual space SV by taking into account the degree of reduction at the time of superimposition in addition to the actual movement amount of the user U, so that it is possible to appropriately provide the virtual space SV in accordance with movement of the user U.

Another example of method of setting correspondence relation

Another example of the method of setting the correspondence relation between the coordinate system of the virtual space SV and the coordinate system of the real space SR described in the present embodiment will be described below.

For example, as explained with reference to FIG. 5 and FIG. 6, if the virtual space SV and the real space SR are superimposed on each other such that the superimposed area is maximum while changing the position, the orientation, or the size of the virtual space SV, the unmovable region AR1 (for example, an actual obstacle) in the real space SR may be located around the unmovable region AV1 (for example, a region of interest) in the virtual space SV, and may become an obstacle at the time of approach to the region of interest in the virtual space SV. In case of the situation as described above, the correspondence relation acquisition unit 44 may set a priority region in the movable region AV2 of the virtual space SV and superimpose the virtual space SV and the real space SR such that the priority region is not superimposed on the unmovable region AR1 in the real space SR. This will be described in detail below.

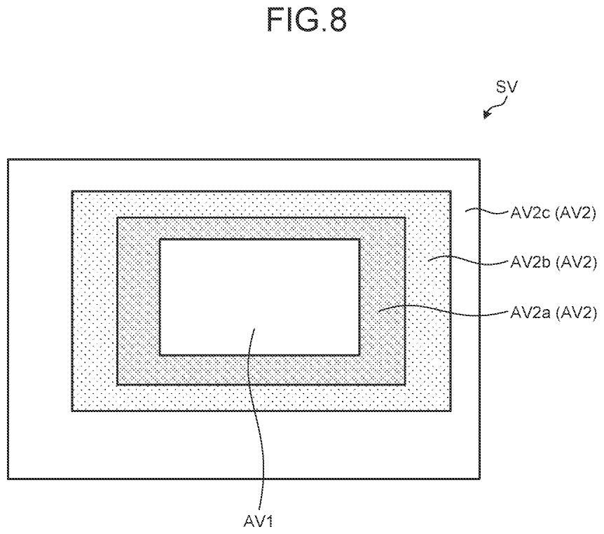

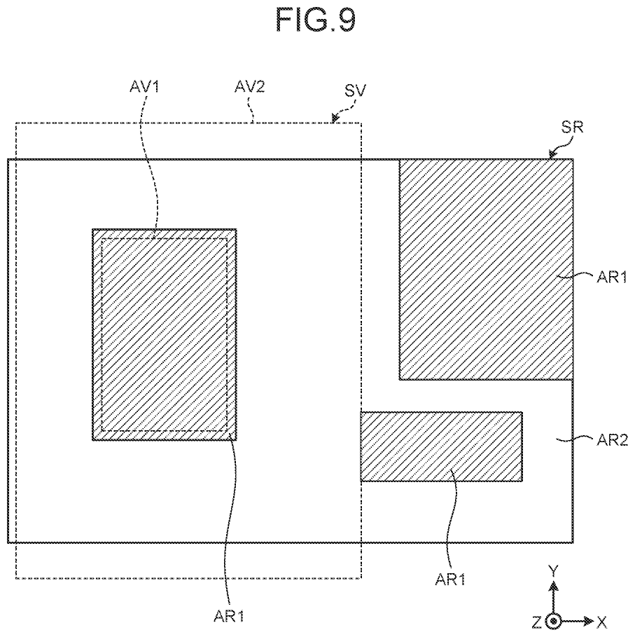

FIG. 8 is a schematic diagram for explaining an example of the priority region, and FIG. 9 is a schematic diagram illustrating another example of superimposition of the virtual space and the real space. The correspondence relation acquisition unit 44 sets the priority region in the movable region AV2 of the virtual space SV. The priority region is a region that is preferentially superimposed on the movable region AR2 without being superimposed on the unmovable region AR1 when the virtual space SV and the real space SR are superimposed on each other. The correspondence relation acquisition unit 44 may set the priority region by an arbitrary method; for example, it may be possible to set, as the priority region, a region with a predetermined size around the unmovable region AV1 that is a region-of-interest in the movable region AV2. Further, the correspondence relation acquisition unit 44 may set a plurality of priority regions with different degrees of priority. In the example illustrated in FIG. 8, the correspondence relation acquisition unit 44 sets a priority region AV2a around the unmovable region AV1 and sets a priority region AV2b around the priority region AV2a. In this case, the degree of priority of the priority region AV2a that is located closer to the unmovable region AV1 is set to higher than the priority region AV2b. Meanwhile, in the following, a region other than the priority region in the movable region AV2 will be appropriately described as a non-priority region. In other words, in the example illustrated in FIG. 9, a region outside the priority region AV2b is a non-priority region AV2c.

The correspondence relation acquisition unit 44 superimposes the virtual space SV in which the priority region is set and the real space SR in the common coordinate system. In this case, as explained above with reference to FIG. 5 and FIG. 6, the correspondence relation acquisition unit 44 calculates the superimposed area while changing at least one of the relative position, the relative orientation, and the relative size of the virtual space SV and the real space SR in the common coordinate system, and sets a correspondence relation between the coordinate system of the virtual space SV and the coordinate system of the real space SR from a combination of the virtual space SV and the real space SR for which the superimposed area is maximum. However, in the present example, the superimposed area is calculated such that a size of a priority superimposed area, which is a superimposed area of the priority region and the movable region AR2, largely affects the superimposed area to be calculated, as compared to a size of a non-priority superimposed area, which is a superimposed area of the non-priority region and the movable region AR2. In other words, the superimposed area is calculated so as to increase with an increase in the priority superimposed area or the non-priority superimposed area; however, the degree of increase in the superimposed area when the priority superimposed area is increased by a unit amount is larger than the degree of increase in the superimposed area when the non-priority superimposed area is increased by a unit amount.

For example, the correspondence relation acquisition unit 44 of the present example adds a weight to the priority superimposed area and calculates a total value of a value that is obtained by multiplying the priority superimposed area by the weight and the non-priority superimposed area as the superimposed area. In this manner, by adding the weight to the priority superimposed area, the degree of influence of the priority superimposed area (the priority region) on the superimposed area is increased as compared to the degree of influence of the non-priority superimposed area (the non-priority region) on the superimposed area. Therefore, for example, as illustrated in FIG. 9, importance is placed on non-superimposition of the priority region around the region of interest (the unmovable region AV1) on the unmovable region AR1, and, in the combination of the virtual space SV and the real space SR for which the superimposed area is maximum, the priority superimposed area is less likely to overlap with the unmovable region AR1. Therefore, for example, it is possible to reduce the possibility that the unmovable region AR1 becomes an obstacle at the time of approach to the region of interest in the virtual space SV.

In this manner, in the present example, the superimposed area is calculated so as to increase with an increase in the priority superimposed area in which the priority region set in the movable region AV2 and the movable region AV2 overlap with each other. The priority region is set such that the degree of influence on the size of the superimposed area is larger as compared to the non-priority region (a region other than the priority region in the movable region AV2). With this configuration, it is possible to reduce the possibility that the unmovable region AR1 becomes an obstacle at the time of approach to the region of interest in the virtual space SV. Meanwhile, when a plurality of priority regions are to be set, it may be possible to change a value of the weight for each of the priority regions. In this case, in the example in FIG. 8, the weight of the priority region AV2a that is located closer to the unmovable region AV1 is set to be larger than the weight of the priority region AV2b.

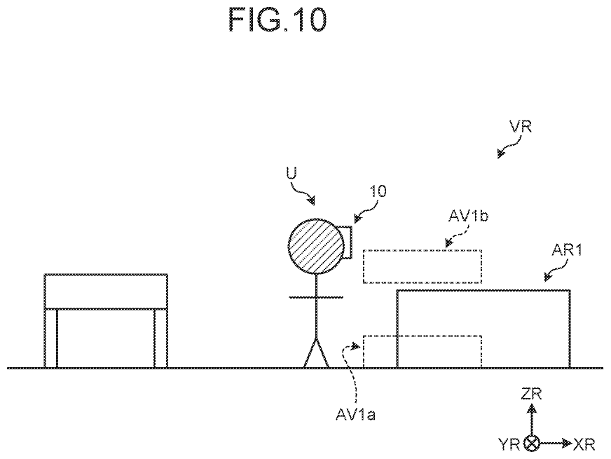

As still another example of the method of setting the correspondence relation, a method of setting the correspondence relation between the position of the real space SR in a height direction and the position of the virtual space SV in the height direction will be described below. FIG. 10 is a schematic diagram illustrating an example in which the user visually recognizes the virtual space. As illustrated in FIG. 10, an unmovable region AV1a that is a region of interest in the virtual space SV overlaps with the unmovable region AR1 that is an obstacle in the real space SV in the height direction (the ZR direction in the real space coordinates), and the region of interest in the virtual space SV may be hidden in some cases. To avoid the situation as described above, the correspondence relation acquisition unit 44 may set the correspondence relation between the position of the real space SR in the height direction and the position of the virtual space SV in the height direction such that the unmovable region AV1 and the unmovable region AR1 do not overlap with each other in the height direction. With this configuration, for example, as indicated by an unmovable region AV1b in FIG. 10, it is possible to set the position of the unmovable region at a position that does not overlap with the unmovable region AR1. Meanwhile, the correspondence relation between the position of the real space SR in the height direction and the position of the virtual space SV in the height direction may be automatically set by the correspondence relation acquisition unit 44, or may be set by input by the user U.

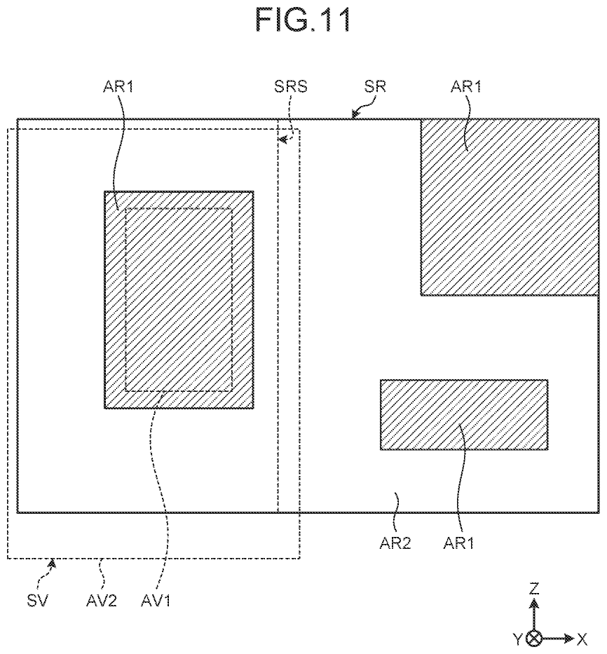

As a still another example of the method of setting the correspondence relation, an example in which the virtual space SV and the real space SR are superimposed on each other such that a degree of similarity between the virtual space SV and the real space SR is increased. FIG. 11 is a schematic diagram illustrating a still another example of superimposition of the virtual space and the real space. In the present example, the correspondence relation acquisition unit 44 compares a shape of the real space SR and a shape of the virtual space SV, and extracts a region of the real space SR with a similar shape to the virtual space SV as a similar region SRS in which the degree of similarity is high. Further, as illustrated in the example in FIG. 11, the correspondence relation acquisition unit 44 superimposes the virtual space SV on the real space SR while changing at least one of the relative position, the relative orientation, and the relative size of the virtual space SV and the real space SR, so that the virtual space SV and the similar region are superimposed on each other. The correspondence relation acquisition unit 44 calculates the correspondence relation between the coordinate system of the virtual space SV and the coordinate system of the real space SR that are superimposed in the similar region SRS. In this manner, by superimposing the virtual space SV in the region in which the degree of similarity is high, it is possible to reduce deviation between the movable region that is recognized by the user U and the actually movable region, so that it is possible to ensure the region in which the user U is movable as wide as possible. Meanwhile, in the present embodiment, it is not needed to take into account the superimposed area at the time of superimposition, but embodiments are not limited to this example, and it may be possible to take into account the superimposed area. In other words, for example, the correspondence relation acquisition unit 44 may superimpose the virtual space SV and the real space SR such that the degree of similarity increases and the superimposed area increases.

According to one embodiment, it is possible to appropriately provide a virtual space to a user.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display apparatus that is worn on a user and provides a virtual space to the user, the display apparatus comprising:
a virtual space information acquisition unit that acquires information on a virtual movement region in which the user is movable in the virtual space;
a real space information acquisition unit that acquires information on a real movement region in which the user is movable in a real space in which the user exists;
a correspondence relation acquisition unit that calculates a superimposed area that is an area in which the virtual movement region and the real movement region are superimposed on each other when the virtual space and the real space are superimposed on each other, and acquires a correspondence relation between the virtual space and the real space, the correspondence relation being set based on the superimposed area; and
a display control unit that causes a display unit to display an image for the virtual space based on the correspondence relation and a position of the display apparatus in the real space, wherein
the correspondence relation acquisition unit calculates the superimposed area for each of combinations of the virtual space and the real space for which at least one of a relative position and a relative orientation of the virtual space and the real space is moved, and acquires a correspondence relation for which the superimposed area is maximum among the superimposed areas.

2. The display apparatus according to claim 1, wherein the correspondence relation acquisition unit calculates the superimposed area for each of combinations of the virtual space and the real space for which a relative size of the virtual space and the real space is changed, and acquires a correspondence relation for which the superimposed area is maximum among the superimposed areas.

3. The display apparatus according to claim 1, wherein
the superimposed area is calculated so as to increase with an increase in an area in which a priority region that is set in the virtual movement region and the real movement region are superimposed on each other, and
the priority region is set such that a degree of influence on a size of the superimposed area increases as compared to a region other than the priority region in the virtual movement region.

4. A method of controlling a display apparatus that is worn on a user and provides a virtual space to the user, the method comprising:
acquiring information on a virtual movement region in which the user is movable in the virtual space;
acquiring information on a real movement region in which the user is movable in a real space in which the user exists;
calculating a superimposed area that is an area in which the virtual movement region and the real movement region are superimposed on each other when the virtual space and the real space are superimposed on each other, and acquiring a correspondence relation between the virtual space and the real space, the correspondence relation being set based on the superimposed area; and
causing a display unit to display an image for the virtual space based on the correspondence relation and a position of the display apparatus in the real space, wherein
the calculating includes
calculating the superimposed area for each of combinations of the virtual space and the real space for which at least one of a relative position and a relative orientation of the virtual space and the real space is moved, and acquiring a correspondence relation for which the superimposed area is maximum among the superimposed areas.

5. A non-transitory computer readable recording medium on which an executable program is recorded, the program causing a computer to implement a method of controlling a display apparatus that is worn on a user and provides a virtual space to the user, the program causing the computer to execute:
acquiring information on a virtual movement region in which the user is movable in the virtual space;
acquiring information on a real movement region in which the user is movable in a real space in which the user exists;
calculating a superimposed area that is an area in which the virtual movement region and the real movement region are superimposed on each other when the virtual space and the real space are superimposed on each other, and acquiring a correspondence relation between the virtual space and the real space, the correspondence relation being set based on the superimposed area; and
causing a display unit to display an image for the virtual space based on the correspondence relation and a position of the display apparatus in the real space, wherein
the calculating includes
calculating the superimposed area for each of combinations of the virtual space and the real space for which at least one of a relative position and a relative orientation of the virtual space and the real space is moved, and acquiring a correspondence relation for which the superimposed area is maximum among the superimposed areas.
